(19) United States
(12) Patent Application Publication
(10) Pub. No.: US 2015/0081390 A1
(43) Pub. Date: Mar. 19, 2015

(54) CUSTOMER SELECTION FOR SERVICE OFFERINGS

(71) Applicant: INTERNATIONAL BUSINESS MACHINES CORPORATION, Armonk, NY (US)

(72) Inventors: JoAnn P. Brereton, Hawthorne, NY (US); Arun Hampapur, Norwalk, CT (US); Hongfei Li, Briarcliff Manor, NY (US); Robin Lougee, Yorktown Heights, NY (US); Buyue Qian, Sacramento, CA (US)

(73) Assignee: INTERNATIONAL BUSINESS MACHINES CORPORATION, Armonk, NY (US)

(21) Appl. No.: 14/027,436

(22) Filed: Sep. 16, 2013

(51) Int. Cl. G06Q 30/02

(52) U.S. Cl. CPC G06Q 30/0201
USPC 705/7.34; 705/7.33

(57) ABSTRACT

An aspect of customer selection processes includes classifying, by a computer processor, customers of an entity into groups based on commonly shared, predefined characteristics among the customers. For each of the groups: services rendered for corresponding customers are identified; for each of the services rendered, a risk relationship and a reward relationship between each of the corresponding customers and the service is determined; and for each of the services rendered, a score that defines a combination of the risk relationship and the reward relationship is calculated. For each of the services rendered by the entity, the corresponding score is applied to a candidate customer having a set of characteristics matching the characteristics of one of the groups, and the service is offered to the candidate customer as a function of the score.

### BACKGROUND

The present invention relates to financial services and, more specifically, to customer selection for offering financial services.

Decisions made in the financial services industry with respect to customer products and services can be wrought with challenges that are influenced by a variety of factors, such as fluctuating market conditions, profitability expectations, and risk tolerances, to name a few. Adding to these challenges are the decisions that need to be made by financial institutions with regard to the numerous types of services that are known and desired by customers.

Currently, financial services organizations attempt to resolve these challenges using an intensive manual process that can also be quite costly. In addition, where there is a lack of information about customers (e.g., new customers who have little or no transaction histories with the service providers), making decisions about which services to offer can present even greater challenges.

In order to be competitive in the marketplace, financial institutions need to be savvy when it comes to rendering these types of decisions.

### SUMMARY

According to one embodiment of the present invention, a method is provided. The method includes classifying, by a computer processor, customers of an entity into groups based on commonly shared, predefined characteristics among the customers. For each of the groups, the method includes identifying services that are rendered for corresponding customers; assessing, for each of the services rendered, a risk relationship between each of the corresponding customers and the service, and assessing a reward relationship between each of the corresponding customers and the service; and calculating, for each of the services rendered, a score that defines a combination of the risk relationship and the reward relationship across the corresponding customers. For each of the services rendered by the entity, the method further includes applying the corresponding score to a candidate customer having a set of characteristics matching the characteristics of one of the groups; and offering, by the computer processor, the service to the candidate customer as a function of the score.

According to another embodiment of the present invention, a system is provided. The system includes a computer processing system and a customer grouping module executable by the computer processing system. The customer grouping module is configured to classify customers of an entity into groups based on commonly shared, predefined characteristics among the customers. The system also includes a service offering and grouping analysis module executable by the computer processing device. The service offering and grouping analysis module is configured to implement, for each of the groups: identifying services that are rendered for corresponding customers; assessing for each of the services rendered a risk relationship between each of the corresponding customers and the service, and assessing a reward relationship between each of the corresponding customers and the service; and calculating, for each of the services rendered, a score that defines a combination of the risk relationship and the reward relationship across the corresponding customers. The system also includes a customer selection module executable by the computer processing device. The customer selection module is configured to implement, for each of the services rendered by the entity: applying the corresponding score to a candidate customer having a set of characteristics matching the characteristics of one of the groups; and offering the service to the candidate customer as a function of the score.

According to a further embodiment of the present invention, a computer program product is provided. The computer program product includes a storage medium embodied with machine-readable program instructions, which when executed by a computer causes the computer to implement a method. The method includes classifying customers of an entity into groups based on commonly shared, predefined characteristics among the customers. For each of the groups, the method includes identifying services that are rendered for corresponding customers; assessing, for each of the services rendered, a risk relationship between each of the corresponding customers and the service, and assessing a reward relationship between each of the corresponding customers and the service; and calculating, for each of the services rendered, a score that defines a combination of the risk relationship and the reward relationship across the corresponding customers. For each of the services rendered by the entity, the method further includes applying the corresponding score to a candidate customer having a set of characteristics matching the characteristics of one of the groups; and offering the service to the candidate customer as a function of the score.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a system upon which customer selection for a service offering may be implemented according to an embodiment of the present invention;

FIG. 2 depicts a flow diagram describing a process for implementing customer selection for a service offering according to an embodiment of the present invention; and

FIG. 3 depicts a data flow diagram for implementing customer selection for a service offering according to an embodiment of the present invention.

### DETAILED DESCRIPTION

Exemplary embodiments provide customer selection processes for offering financial services. The embodiments include segmenting a customer base into groups of customers, whereby each group consists of customers having the same or similar predefined characteristics. For each of the groups, risk and reward relationships are analyzed among the services (e.g., credit and savings accounts) provided to the customers based on historical transaction information, a score value is calculated that combines the results of these analyses, and the score value and results are stored. As new customers, or existing customer candidates, are identified, they are evaluated and assigned to the groups according to these predefined characteristics. The embodiments include iteratively selecting services and using the associated score to determine which of the new or candidate customers to offer the services. These and other features of the customer selection processes will now be described.

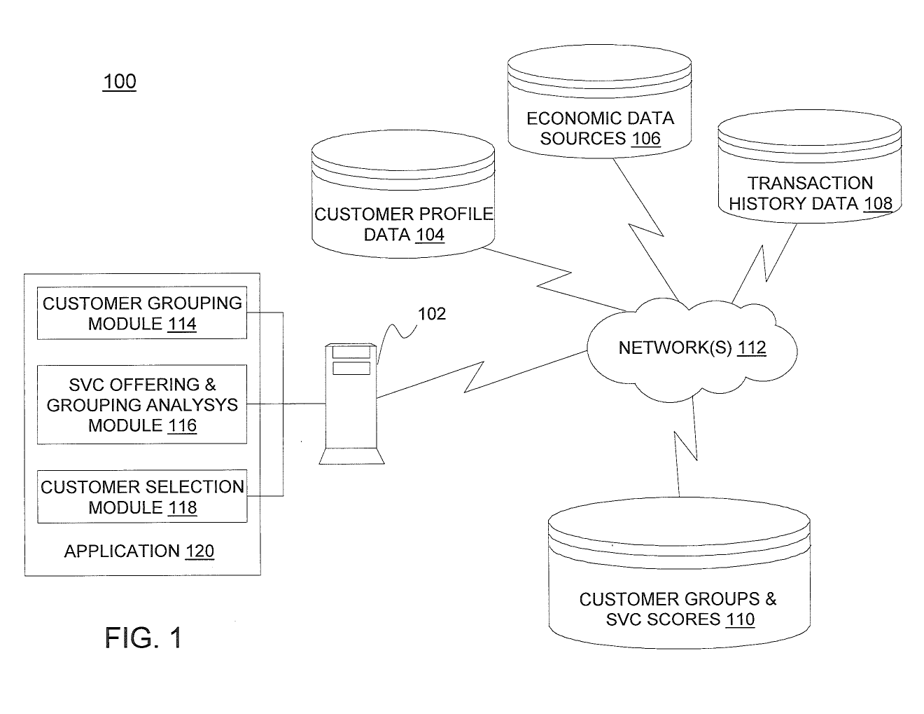

Turning now to FIG. 1, a system 100 upon which the customer selection for service offering processes may be implemented will now be described in an exemplary embodiment. The system 100 of FIG. 1 includes a host system 102 in communication with various data sources 104-110 over one or more networks 112.

The host system 102 may be implemented as a high-speed computer processing device (e.g., a mainframe computer) that is capable of handling a large volume of data received from the data sources 104-110. The host system 102 may be implemented by any entity or enterprise that collects and processes a large amount of data from a multitude of data sources (e.g., data sources 104-110) to manage, or may be offered as a service to such entity by, e.g., an application service provider (ASP). In an embodiment, the host system 102 is implemented by a financial institution that offers various financial-related services to its customers, such as credit account offerings and savings account offerings, as well as various differing terms, such as transaction risk daily limits.

The data sources 104-110 are implemented as data storage devices that are configured to receive and store information for access by computer systems, such as the host system 102. In FIG. 1, these data sources 104-110 are shown as individual data storage devices; however, it will be understood that fewer or greater numbers of storage devices may be employed (e.g., data stored in two or more data sources may be integrated into a single storage device) in realizing the advantages of the embodiments described herein. In addition, while shown in FIG. 1 as being coupled to the host system 102 through networks 112, it will be understood that one or more of the data sources 104-110 may be directly in communication with the host system 102 (e.g., via cabling). Alternatively, one or more of the data sources 104-110 may be logically addressable by the host system 102, e.g., as a consolidated data source over one or more of the networks 112.

In particular, the data sources include a storage device 104 that stores customer profile data, a storage device 106 that stores economic and/or market data, a storage device 108 that stores transaction history data, and a storage device 110 that stores customer groups and service scores.

Customer profile data may include information derived from customer accounts stored and managed by the host system 102. For example, customer profile data may include customer type (e.g., business, personal consumer, for-profit, non-profit, charitable, etc.), customer geographic location(s), number of employees, annual revenue, industry of customer business (e.g., manufacturing, retail, health care, insurance, etc.), and customer age. Customer profile data may be used to determine similarities among various customers of the entity associated with the host system 102. The customer profile data may be used to define characteristics as a foundation to group customers that share similar traits. For example, one characteristic may be the size of the customer in terms of the number of employees and/or the annual revenue generated by the customer. Another characteristic may be type of business the customer is engaged in. The characteristics may be customized by an administrator of the customer selection processes, if desired.

Economic and market data include economic health of the particular customer, the economic health of the region in which the customer operates, the economic health of the industry in which the customer operates, and/or the current health of the national or global market as a whole. Economic health data may be obtained for a particular customer in part, e.g., from an annual financial report published by the customer or credit scores obtained from a credit report. Economic health information about a region, industry, etc. of the market may be obtained, e.g., from the stock market, current interest rates, industry news reports, etc. The economic health of a particular customer, region of the customer, and industry of the customer may be used, similar to the customer profile data, to group customers that share similar economic health traits. The health of the market as a whole can also be used in implementing the customer selection processes described herein. For example, in a healthy market, additional services (or services having more customer-favored terms) may be offered to more of the customers of the enterprise, as compared to what may be offered in a lean market.

Transaction history data include historical information about the transactions conducted between the customer and the enterprise. For example, transaction history data may include frequency of transactions, a frequency and dates of transactions involving a customer's daily limits (cash or credit), any defaults that may have occurred and the dates of the defaults, and average dollar amount of transactions over a period of time, to name a few.

Customer groups and service scores include information derived from processing the customer profile data and transaction history data. The customer groups refer to the classification or segmentation of the customers based on the above-referenced characteristics. For example, one group may include all manufacturing-based customers with a size of 500 or more employees. Groups may be further drilled down more granularly, e.g., a group consisting of all manufacturing-based customers with a size of 50-150 employees and having U.S. facilities in the Northeast. The service scores are derived from analyses of risk and reward relationships, and are described further herein.

Turning back to FIG. 1, the networks 112 may include any type of networks, such as local area networks, wide area networks, virtual private networks, and the Internet. In addition, the networks 112 may be configured to support wireless communications, e.g., via radio frequency (RF) communications, cellular networks, satellite networks, and global positioning (GPS) systems.

The host system 102 executes program modules for implementing the exemplary customer selection processes, as well as other processes, as described herein. The modules include a customer grouping module 114, a service offering and grouping analysis module 116, and a customer selection module 118, which are collectively referred to as application 120.

The customer grouping module 114 receives or obtains customer profile data from storage device 104, along with economic data from storage device 106, and processes the data to identify similarities among the customers. Predefined characteristics, as described above, may be used to classify the customers into groups, which are then stored in the storage device 110.

The service offering and grouping analysis module 116 looks at each of the groups and identifies services that are currently provided to the customers associated with each group. The service offering and grouping analysis module 116 also retrieves transaction history data from the storage device 108 and analyzes risk and reward relationships between the customers for each group and the services offered in view of the corresponding transaction histories. For example, through the analysis, it is determined that 44 percent of customers in a first group have never been in a default status for a particular service provided to the customers. Further, it is determined that another 38 percent have been in default once over the life of the service provided. In addition, it is determined that providing this particular service to the customers in this first group has yielded a desired profit to the enterprise of the host system 102. The risk relationship involves the percentage of default with respect to the number of customers in the group for the particular service, while the reward relationship involves the percentage of non-defaults combined with the desired profits obtained for the service and the group. The service offering and grouping analysis module 116 utilizes business rules that apply a combined score value that defines the risk/reward relationships. The business rules may be configured (and modified) to define the amount or extent of risk balanced by the desired reward for each enterprise utilizing the customer selection processes. In an embodiment, the business rules may be configured such that if the combined score value meets or exceeds a threshold value defined for the particular group and service, the service may be deemed appropriate for offering to future customers that meet the characteristics defined for the respective group. Alternatively, when the combined score value does not meet the threshold value, the service may not be offered to the future customer.

The customer selection module 118 determines to which new or candidate customers a service will be offered. For example, when new customers are identified by the system, they are placed in one of the groups using the customer grouping module 114. The customer selection module 118 iteratively selects from the services offered by the entity, selects a group from the customer groups, and compares the combined service score of the service for the group to a threshold value set by the system. If the service score meets or exceeds the threshold value, the customer selection module 118 identifies customers in the group that currently do not receive this service. The service is then offered to the customer. The customer selection module 118 then selects the next service offered, and the above process is repeated until each service and each group is completed.

As indicated above, in an embodiment, the customer selection processes (e.g., via the application 120) may also include a user interface component for enabling authorized users to customize customer profile characteristics, business rules and/or threshold values used in the customer selection processes described herein.

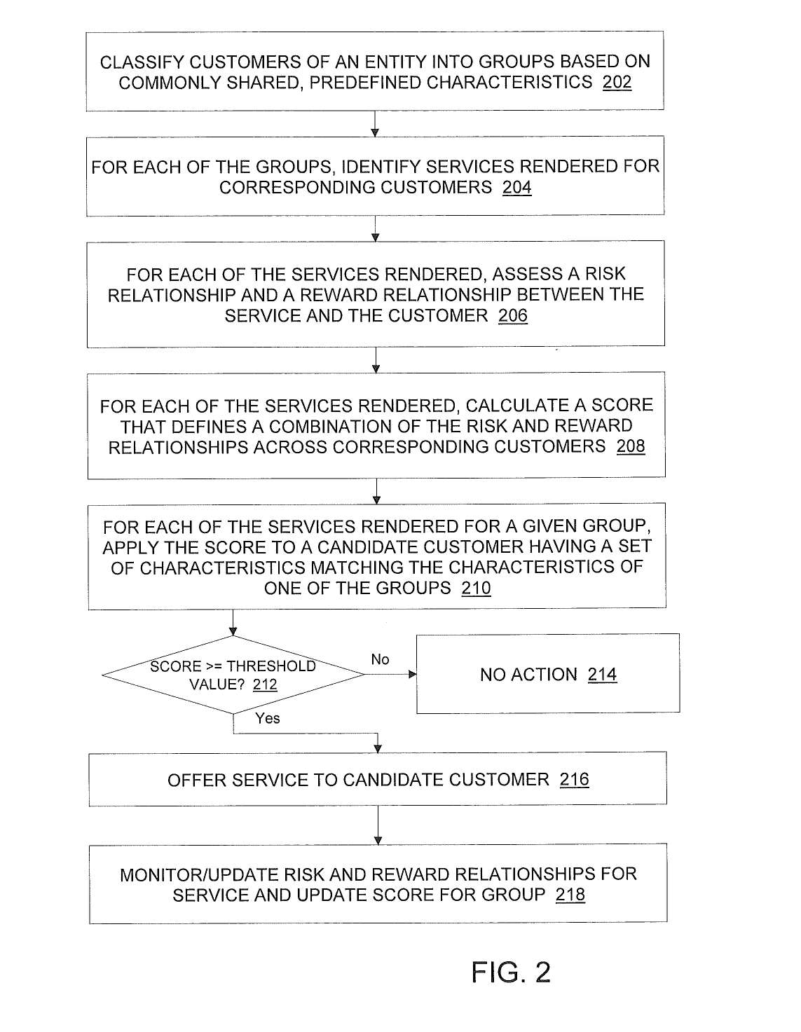

Turning now to FIG. 2, a flow diagram describing a process for implementing customer selection for service offerings will now be described in an exemplary embodiment.

At step 202, existing customers that have an established history of business interactions with the entity or financial enterprise of the host system 102 are classified into groups via the customer grouping module 114 based on commonly-shared, predefined characteristics from collected customer profile data. In addition to the customer profile data, the customer grouping module 114 may factor in the economic health of the customer, region in which the customer is located, industry in which the customer works, or the economic health of the market itself.

At step 204, for each of these groups, the service offering and grouping analysis module 116 identifies services that are currently, or have recently been, rendered to the corresponding customers. The services may be defined as credit or other financial-related offerings, and may further be defined according to terms associated therewith (e.g., daily transaction limits, credit amount authorized, interest rates, etc.). For example, one service may be a credit line of $75,000 with a daily transaction limit of $5,000 and an interest rate of 11%, while another service may be a credit line of $100,000 with a daily transaction limit of $15,000, and an interest rate of 12%.

At step 206, for each of the groups and for each of the services rendered, the service offering and grouping analysis module 116 used the customer transaction history information from storage device 108 to assess a risk relationship between each of the corresponding customers and service offered, and also assesses a reward relationship between each of the corresponding customers and service offered.

At step 208, for each of the groups and for each of the services rendered, the service offering and grouping analysis module 116 calculates a score that defines a combination of the risk relationship and the reward relationship across the corresponding customers. The resulting customer groups and corresponding service scores are stored in the storage device 110.

Once the customer groupings have been determined and the service scores calculated, the customer selection processes can apply this information to new or candidate customers to determine whether a particular service should be offered. In particular, the new or candidate customer is assigned to one of the groups via the process in step 202, a service is selected from the service offerings, and the customer selection module 118 uses the service score for that group to determine whether to offer the service to the new or candidate customer. Thus, the service offering for a candidate customer is a function of the score.

In particular, in step 210, the customer selection module 118 applies the score to the candidate customer based on the customer's assigned group and, at step 212, it is determined whether the score meets a threshold value. If not, the customer for this group is not deemed a desirable candidate and no further action is taken at step 214. Otherwise, at step 216, if the score meets the threshold value, the service is offered to this candidate customer (and any other candidate customers in the group). The application 120, in a closed loop fashion, monitors and updates risk and reward relationships over time and updates the service scores as appropriate at step 218.

In an embodiment, the economic health of the candidate customer may be considered in determining whether a service should be offered. This information may be obtained, e.g., from credit rating bureaus. In this embodiment, the economic health may be factored in combination with the service score in the determination.

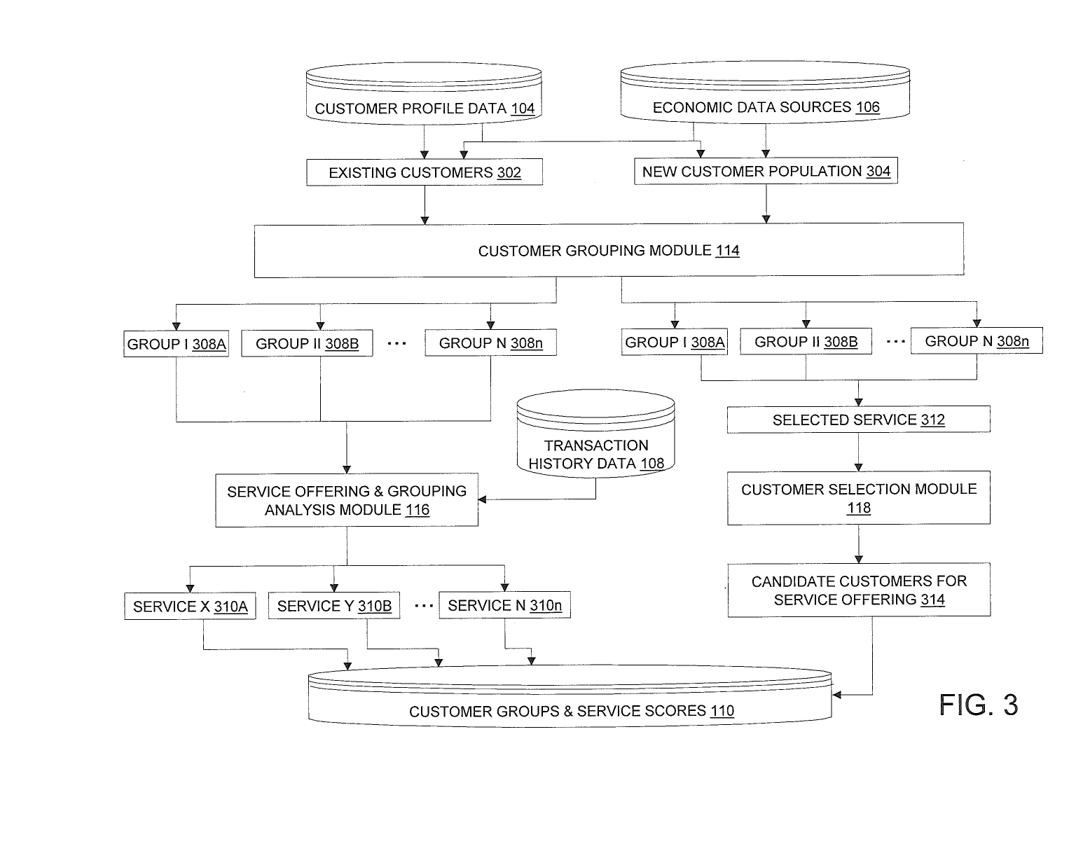

Turning now to FIG. 3, a data flow diagram illustrating the customer selection processes will now be described. As shown in FIG. 3, customer profile data for existing customers 302 from storage device 104 and economic data from storage device 106 are retrieved and processed by the customer grouping module 114. The customer grouping module 114 assigns each of the existing customers 302 to groups 308A-308n as shown in FIG. 3.

For the existing customers 302, the service offering and grouping analysis module 116 retrieves transaction history data from storage device 108, and for each of the groups 308A-308n of customers and, within each of these groups, for each of the services provided to the existing customers 302, the service offering and grouping analysis module 116 evaluates risk and reward relationships between the customers and the services.

The service offering and grouping analysis module 116 calculates a combined risk/reward value from the analyses for each of the services of a given group of customers. As shown in FIG. 3, services 310A-310n for each group are output along with their service scores to the storage device 110.

In addition to processing the information for the existing customers 302, as shown in FIG. 3, information relating to new customers 304 (e.g., those who have established little or no transactional relationship with the entity), along with the economic data, is processed by the customer grouping module 114. The customer grouping module 114 assigns each of the new customers 304 to groups 308A-308n, as shown in FIG. 3. As indicated above, these groups 308A-308n may be stored in the storage device 110; however, they are not processed by the service offering and grouping analysis module 116, as they have no transaction histories.

The customer selection module 118 selects a service 312, as part of an iterative process of selecting services, selects a group for which the service is offered, and if the combined service score for the service of the selected group meets or exceeds a defined threshold value, the customer selection module 118 determines that customers within that group are eligible for the service. The customer selection module 118 identifies these candidate customers for the service offering 314, and the storage device 110 is updated to reflect this information.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A method, comprising:
classifying, by a computer processor, customers of an entity into groups based on commonly shared, predefined characteristics among the customers;
for each of the groups:
identifying services that are rendered for corresponding customers;
assessing, for each of the services rendered, a risk relationship between each of the corresponding customers and the service, and assessing a reward relationship between each of the corresponding customers and the service; and
calculating, for each of the services rendered, a score that defines a combination of the risk relationship and the reward relationship across the corresponding customers; and
for each of the services rendered by the entity:
applying the corresponding score to a candidate customer having a set of characteristics matching the characteristics of one of the groups; and
offering, via the computer processor, the service to the candidate customer as a function of the score.

2. The method of claim 1, wherein the offering the service to the candidate customer as a function of the score includes offering the service when the score meets a threshold value.

3. The method of claim 1, wherein the predefined characteristics include at least one of:
customer type;
customer geographic location;
number of employees;
industry of customer business; and
customer age.

4. The method of claim 1, further comprising:
collecting market data reflecting a current economic health of each of the customers receiving the services rendered, wherein the predefined characteristics for each of the groups include the current economic health; and
factoring the current economic health of each of the customers into the score.

5. The method of claim 1, further comprising:
collecting data reflecting a current economic health of the candidate customer;
wherein the offering the service to the candidate customer as a function of the score includes offering the service when the score meets a threshold value and when the current economic health of the candidate customer meets a threshold value.

6. The method of claim 1, wherein the risk relationship and the reward relationship are calculated using transaction histories of each of the customers with respect to each of the services rendered.

7. The method of claim 1, wherein the service offered to the candidate customer includes at least one of:
a credit account having terms defined based on the score; and
a savings account having terms defined based on the score.

8-14. (canceled)

15. A computer program product comprising a storage medium embodied with machine-readable program instructions, which when executed by a computer, causes the computer to implement a method, the method comprising:
classifying customers of an entity into groups based on commonly shared, predefined characteristics among the customers;
for each of the groups:
identifying services that are rendered for corresponding customers;
assessing, for each of the services rendered, a risk relationship between each of the corresponding customers and the service, and assessing a reward relationship between each of the corresponding customers and the service; and
calculating, for each of the services rendered, a score that defines a combination of the risk relationship and the reward relationship across the corresponding customers; and
for each of the services rendered by the entity:
applying the corresponding score to a candidate customer having a set of characteristics matching the characteristics of one of the groups; and
offering the service to the candidate customer as a function of the score.

16. The computer program product of claim 15, wherein the offering the service to the candidate customer as a function of the score includes offering the service when the score meets a threshold value.

17. The computer program product of claim 15, wherein the predefined characteristics include at least one of:
customer type;
customer geographic location;
number of employees;
industry of customer business; and
customer age.

18. The computer program product of claim 15, wherein the method further comprises:
collecting market data reflecting a current economic health of each of the customers receiving the services rendered, wherein the predefined characteristics for each of the groups include the current economic health; and
factoring the current economic health of each of the customers into the score.

19. The computer program product of claim 15, wherein the method further comprises:
collecting data reflecting a current economic health of the candidate customer;
wherein the offering the service to the candidate customer as a function of the score includes offering the service when the score meets a threshold value and when the current economic health of the candidate customer meets a threshold value.

20. The computer program product of claim 15, wherein the risk relationship and the reward relationship are calculated using transaction histories of each of the customers with respect to each of the services rendered; and
wherein the service offered to the candidate customer includes at least one of:
a credit account having terms defined based on the score; and
a savings account having terms defined based on the score.
